(19) United States
(12) Patent Application Publication
(10) Pub. No.: US 2010/0040114 A1
(43) Pub. Date: Feb. 18, 2010

(54) INTRA-BODY COMMUNICATION SYSTEM FOR HIGH-SPEED DATA TRANSMISSION

(75) Inventors: Tae-Joon Kim, Seoul (KR); Sung-Weon Kang, Daejon (KR); Kyung-Soo Kim, Daejon (KR); Jung-Bum Kim, Daejon (KR); In-Gi Lim, Daejon (KR); Chang-Hee Hyoung, Daejon (KR); Hyung-II Park, Daejon (KR); Duck-Gun Park, Daejon (KR); Sung-Eun Kim, Seoul (KR); Jin-Kyung Kim, Daejon (KR); Jung-Hwan Hwang, Daejon (KR); Jin-Bong Sung, Daejon (KR); Hyuk Kim, Daejon (KR); Ki-Hyuk Park, Daejon (KR)

Correspondence Address: AMPACC Law Group, 3500 188th Street S.W., SUITE 103, Lynnwood, WA, 98037, US

(73) Assignee: Electronics and Telecommunications Research Institute, Daejon (KR)

(21) Appl. No.: 12/442,971

(22) PCT Filed: Sep. 28, 2007
(86) PCT No.: PCT/KR2007/004767

§ 371 Date: Mar. 26, 2009

(30) Foreign Application Priority Data
Apr. 3, 2008 (KR) 10-2006-0096272

(51) Int. Cl. H04B 1/69; H04L 27/22

(52) U.S. Cl. 375/130; 375/343; 375/E01.001

(57) ABSTRACT

Provided is an intra-body communication system which enables high-speed data transmission while limiting the frequency band of a signal being transmitted through a human body to a frequency range (e.g., 30-40 MHz) where the human body can maintain waveguide properties and enables stable intra-body communication by minimizing interference by other users or other electronic devices. A transceiver of the intra-body communication system for high-speed data transmission includes: a source encoder for encoding source information to digital transmission data; a channel error prevention unit for inserting a redundant bit to the encoded transmission data; a mapper for symbolizing the transmission data outputted from the channel error prevention unit; a spreader for performing spread spectrum on the symbolized transmission data in a frequency domain; and a pulse shaping and modulator for generating a baseband signal with a band range limited to a frequency range where the human body retains waveguide properties.

### TECHNICAL FIELD

The present invention relates to an intra-body communication system for high-speed data transmission; and, more particularly, to an intra-body communication system which enables high-speed data transmission while limiting the frequency band of a signal being transmitted through a human body to a frequency range (e.g., 30-40 MHz) where the human body can maintain waveguide properties and enables stable intra-body communication by minimizing interference by other users or other electronic devices.

This work was supported by the Information Technology (IT) research and development program of the Korean Ministry of Information and Communication (MIC) and/or the Korean Institute for Information Technology Advancement (IITA) [2006-S-072-01, “Controller SoC for Human Body Communications”].

### BACKGROUND ART

It is known that an ‘intra-body communication’ refers to a technology of transmitting information to an electrode of a transmitter having attached to a part of the body by using the electrically conductive body as a communication channel, and of recovering the transmitted information by contacting with an electrode of a receiver attached to another part of the body or being located out of the body. It enables communications between portable equipments such as Personal Digital Assistant (PDA), portable personal computer, digital camera, MP3 player, cellular phone, etc., or communications with fixed equipments for prints (communication with a printer), credit card settlement, TV receiving, entrance (communication with an entrance system), bus and subway fare payment, etc., through a simple contact of a user.

Unlike general communication channels which fall under isotropic channels (air, waveguide, water and so forth) that exhibit good characteristics for signal transmission, a so-called human body channel exhibits anisotropic properties and at the same time suffers much loss and many interference signals being induced from surroundings to the body. In addition, since the human body is built up with a variety of matters and forms and has properties such as high permittivity, it shows waveguide properties in a low frequency range while functioning as an antenna in a high frequency range.

One of the conventional intra-body communication technologies is a technology based on the photoelectric effect, which applies a digital signal (such as a Non Return to Zero (NRZ) signal) directly to a body and receives it by employing the photoelectric effect. This technology markedly enhanced transmission speed, attaining 10 Mbps communication speed. Such a high-speed data transmission expanded application fields having been limitedly used to date, and opened a new chapter in broader applications down to everyday life.

Despite the technical advances in communication speed, the conventional technology using the photoelectric effect had difficulties in applying to a small-size portable device because of the size of a module, power consumption, and technical problems like interference from other lighting.

As an attempt to resolve such problems, there were introduced technologies based on an electrical recovering method. This employs on-off-keying schemes making use of a relatively low frequency band (a band around 1 MHz), thereby reducing the energy emission to outside of the body. Moreover, there is a technology that adopts a Direct Sequence Spread Spectrum (DSSS) scheme for minimizing the interference between adjacent users who transmit information by using the same band, and inhibiting information of a current user from being received by another user.

However, in order to exhibit a desired performance by using DSSS within 1 MHz band, data that can be actually transmitted should be less than about 100 Kbps. Further, if each user is assigned with a different PN code sequence to prevent the information of a current user from being received by another user, the data rate that can be actually transmitted is remarkably reduced. Therefore, this scheme is not appropriate for services requiring high data rates, besides the voice service (service for transferring voice signals).

In addition, in order to transmit digital signals of more than several Mbps by using the DSSS scheme, several tens to several hundreds of MHz bandwidth is needed, and when such signals are applied to a body, some signals with particular frequency or higher are radiated. Thus, if there are many users, the radiated signals cause an interference to other users without any contact, making stable communications difficult. In such a case, PN sequence length has to be limited to prevent the radiation of signals with particular frequency or higher, which limits a processing gain. In result, using only the DSSS scheme makes insufficient to attain performance suitable for the service being used.

Furthermore, when the DSSS scheme is employed alone for signal demodulation, signal information of a specific part may be all lost due to interference signals from various kinds of electronic devices and jammers used on the periphery of the user, besides the interference by other users. Even though an error may occur in some parts of chips within a spread spectrum symbol, this leads to a reduction in the order of processing gain to 2. This means that when the intra-body communication requires services of higher data rates (for example, moving/still image transmission, high quality music transmission, etc.) than services simply providing voice signals are required, a desired performance (BER: 10⁻⁵ to 10⁻⁶) may not be attained simply by using spread-spectrum technology.

Therefore, there is a need for a new scheme capable of obtaining a higher level gain than an interference signal entering the body in order to get a desired performance.

### DISCLOSURE OF INVENTION

### Technical Problem

It is, therefore, an object of the present invention to provide an intra-body communication system which enables high-speed data transmission while limiting the frequency band of a signal being transmitted through a human body to a frequency range (e.g., 30-40 MHz) where the human body can maintain waveguide properties and enables stable intra-body communication by minimizing interference by other users or other electronic devices.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a transceiver of intra-body communication system for high-speed data transmission, which includes: a source encoder for encoding source information to digital transmission data; a channel error prevention unit for inserting a redundant bit to the encoded transmission data to enable a receiving side to correct an error on a human body channel; a mapper for symbolizing the transmission data outputted from the channel error prevention unit by a given modulation method; a spreader for performing spread spectrum on the symbolized transmission data in a frequency domain by using a spread code with a given code length depending on a data transmission rate and limited frequency range; and a pulse shaping and modulator for generating a baseband signal with a band range limited to a frequency range where the human body retains waveguide properties with respect to the transmission data having been subjected to the spread spectrum in the spreader, and performing digital quadrature modulation on the baseband signal.

In accordance with another aspect of the present invention, there is provided a transmitter of an intra-body communication system for high-speed data transmission, which includes: a source encoder for encoding source information to digital transmission data; a channel error prevention unit for inserting a redundant bit to the encoded transmission data to enable a receiving side to correct an error on a human body channel; a mapper for symbolizing the transmission data outputted from the channel error prevention unit by a given modulation method; a serial to parallel converter for converting symbols serially outputted from the mapper to a parallel arrangement; a spreader for individually diffusing each symbol being arranged in parallel in the serial to parallel converter, and summating the diffused symbols in the unit of chip; a multi-carrier modulator for performing multi-carrier modulation on the diffused symbols being summated in the unit of chip at the spread means; and a pulse shaping and modulator for generating a baseband signal with a band range limited to a frequency range where the human body retains waveguide properties with respect to the transmission data having been subjected to the multi-carrier modulation in the multi-carrier modulator, and performing digital quadrature modulating on the baseband signal.

In accordance with another aspect of the present invention, there is provided a receiver of an intra-body communication system for high-speed data transmission, which includes: a coherent detector & matched filter for detecting, by using a coherent detection method, an original information signal from a signal received through a human body channel, and for extracting a signal that matches with a pulse shaped transmitted signal on a transmitting side from the detected information signal; a despreader for despreading data outputted from the coherent detector & matched filterer to recover symbol data; a demapper for demapping the recovered symbol data from the despreader into data bits; a channel error corrector for correcting an error on the human channel with respect to the data bits outputted form the demapper; and a source decoder for decoding the digital received data with the channel error having been corrected in the channel error corrector to source information.

In accordance with another aspect of the present invention, there is provided a receiver of an intra-body communication system for high-speed data transmission, which includes: a coherent detector & matched filter for detecting, by using a coherent detection method, an original information signal from a signal received through a human body channel, and extracting a signal that matches with a pulse shaped transmitted signal on a transmitting side from the detected information signal; a multi-carrier demodulator for performing multi-carrier demodulation on a plurality of signals outputted from the coherent detector & matched filter; a despreader for copying an input signal from the multi-carrier demodulator per sample to generate a plurality of input signals, and dispreading the plurality of generated input signals in parallel to recover original data; a parallel to serial converter for serially arranging the original data outputted in parallel from the despreader; a demapper for demapping the serially arranged data into data bits; a channel error corrector for correcting an error generated on the human channel with respect to the data bits outputted form the demapper; and a source decoder for decoding the digital received data with the channel error having been corrected in the channel error corrector to source information.

The present invention is directed to a technology for transmitting information using a human body as a medium, and particularly to a technology that can acquire a sufficient gain in sending/receiving a large amount of data using a human body of great loss as a medium.

For a plurality of adjacent users to do stable intra-body communication without interferences, an occupied frequency of a signal being transmitted through a body has to retain waveguide properties to a certain extent. That is, the frequency range for the intra-body communication has to be restricted to lower than a frequency affecting other adjacent people.

In the intra-body communication system using a human body as a channel, an available frequency is limited, so communication speed would be restricted considerably if the intra-body communication system is implemented based on direct transmission of digital signals. The intra-body communication system implemented in this way provides a maximum communication speed of 10 Mbps, but its signal contains many high-frequency signals. In terms of an occupied frequency band, at least several tens of MHz signals are applied to the body and these high frequency components are not confined to the body but are radiated to other adjacent users, causing interference.

Furthermore, even though adverse effects from other adjacent people could be minimized by limiting the frequency band, interference from various electronic devices or other unexpected jammers used on the periphery might function as a burst noise to seriously interfere signals of a certain interval. In other words, it gets very difficult to implement a stable intra-body communication under such circumstances.

Therefore, in view of the foregoing problems, the present invention provides a communication method for realizing stable communications in an environment where limited frequencies are used and electromagnetic interference induced from various electronic devices to a human body is present. In addition, the present invention suggests a method capable of improving frequency usage efficiency in a limited frequency range.

For instance, for data transmission and reception between communication devices connected to a human body by using the body as a communication channel, the present invention not only reduces interference between users but also enables stable intra-body communications even in presence of strong inference being induced from other electronic devices based on the characteristics of the human body channel. Moreover, the present invention provides a communication method effective for increasing data transmission speed within a limited frequency range, and particularly suggests a multiple access method using the same.

In the present invention, an occupied frequency of a signal being transmitted through a body is limited to less than a frequency for the body to retain waveguide properties to a certain extent. To this end, a transceiver of intra-body communication system is provided with means for generating a sufficient gain to detect signals to be received from all possible interference environments even in circumstances of limited available frequency band. Moreover, the present invention also employs a multiplexing method for enabling high-speed data transmission while maintaining a sufficient gain in a transceiver.

### ADVANTAGEOUS EFFECTS

By limiting a signal being transmitted through a human body to a predetermined range (e.g., 30 to 40 MHz) by taking into account the characteristics of a human body channel, the present invention enables the body to retain waveguide properties for preventing signal radiation and is also able to provide a service of desired performance even in strong-interference environment. Moreover, the present invention enables high-speed communications through multiplexing while guaranteeing a sufficient gain.

In other words, according to the present invention, the frequency band of a signal that can be applied to a human body is limited, thereby reducing interference among users nearby and improving high data transmission speed while getting a maximum gain even in the limited frequency band.

In addition, when intra-body communication is done in an environment where there are many users, the present invention not only reduces interference among users, but also provides stable intra-body communication despite strong interferences being induced from other electronic devices.

### BRIEF DESCRIPTION OF THE DRAWINGS

FIG. 1 is a block diagram illustrating an intra-body communication system for high-speed data transmission in accordance with a first embodiment of the present invention.

FIG. 2 is a block diagram illustrating an intra-body communication system for high-speed data transmission in accordance with a second embodiment of the present invention.

FIG. 3 is a detailed block diagram of the spread bank shown in FIG. 2 in accordance with the present invention.

FIG. 4 is a detailed block diagram of the despread bank shown in FIG. 2 in accordance with the present invention.

FIG. 5 is a graph comparing performances with or without a convolutional encoder and a Viterbi decoder.

### BEST MODE FOR CARRYING OUT THE INVENTION

The advantages, features and aspects of the invention will become apparent from the following description of the embodiments with reference to the accompanying drawings, which is set forth hereinafter. Thus, the present invention will be easily carried out by those skilled in the art. Further, in the following description, well-known arts will not be described in detail if it seems that they could obscure the invention in unnecessary detail. Hereinafter, preferred embodiments of the present invention will be set forth in detail with reference to the accompanying drawings.

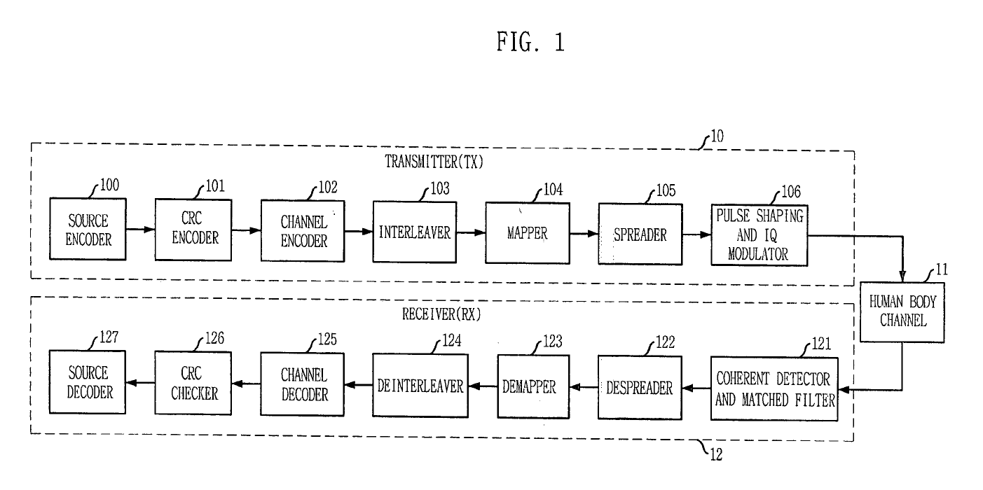

FIG. 1 is a block diagram illustrating an intra-body communication system for high-speed data transmission in accordance with a first embodiment of the present invention, and particularly shows a structure of a transceiver for attaining a sufficient gain when a human body is used as a communication channel.

A transmitter 10 includes a source encoder 100, a CRC encoder 101, a channel encoder 102 selectively supporting a Hybrid Automatic Repeat reQuest (HARQ) function, an interleaver 103, a mapper 104, a spreader 105, and a pulse shaping and IQ modulator 106.

A receiver 12 includes a coherent detector & matched filter 121, a despreader 122, a demapper 123, a deinterleaver 124, a channel decoder 125 selectively supporting an HARQ function, a CRC checker 126, and a source decoder 127.

First of all, a description will be made for the transmitter 10 of the intra-body communication system for high-speed data transmission.

The source encoder 100 encodes source information to digital transmission data, and then the CRC encoder 101 inserts a Cyclic Redundancy Check (CRC) code into the encoded data for error correction on the receiving side. Here, the CRC encoder 101 does not need to be necessarily provided.

The channel encoder 102 carries out channel encoding on an output from the CRC encoder 101, and selectively supports the HARQ function. The interleaver 103 performs block interleaving to change a burst error to a random error. Here, the channel encoder 102 together with the interleaver 103 can serve as a ‘channel error prevention unit’, which inserts a redundant bit to the transmission data encoded by the CRC encoder 101 to correct, on the receiving side, an error on a human body channel.

The mapper 104, which is a constellation mapper, symbolizes the transmission data from the channel error prevention unit 102 and 103 by a predetermined modulation method (e.g., QPSK). The spreader 105 performs spread-spectrum on the symbolized transmission data in a frequency domain by using a spread code with a given code length depending on a data transmission rate and limited frequency range.

The pulse shaping and IQ modulator 106 generates a baseband signal with a band range limited to ‘a frequency range where a human body can retain waveguide properties’ with respect to the transmission data being outputted from the spreader 105, and then conducts digital quadrature modulation on the baseband signal.

In the present invention, an occupied frequency of a signal being transmitted through a human body is limited to less than a frequency where the body can retain waveguide properties to a certain extent.

Now, the receiver 12 of the intra-body communication system for high-speed data transmission will be explained in detail.

The coherent detector & matched filter 121 detects, by using a coherent detection method, an original information signal from a signal received through the human body channel 11, and extracts a signal that matches with a pulse shaped transmitted signal from the transmitting side from the detected information signal.

The despreader 122 despreads data outputted from the coherent detector & matched filter 121 to recover symbol data, and the demapper 123 demaps the recovered symbol data from the despreader 122 into bits of data.

Thereafter, the deinterleaver 124 carries out deinterleaving on the data bits outputted from the demapper 123, and the channel decoder 125 selectively supports the HARQ function. Here, both the deinterleaver 124 and the channel decoder 125 are for correcting an error on a human body channel with respect to the data bits outputted from the demapper 123, so they may be called ‘a channel decoding block’.

In addition, the present invention system is provided with a CRC checker 126 to check a frame error. This CRC checker 126 is needed if the CRC encoder 101 is provided in the transmitter 20.

Lastly, the source decoder 127 decodes the digital received data with the channel error having been corrected to corresponding source information.

Hereinafter, the main technical features of the intra-body communication system of the present invention as above will be described in detail.

Particularly, the present invention system uses the coherent detector 121. This is because performing coherent detection using both signal size component and phase component can obtain 3 dB power gain, compared with a traditional method of using signal size only.

In addition, the matched filter 121 serves to extract a signal that matches with a transmitted signal whose pulse has been shaped in the pulse shaping and IQ modulator 106 of the transmitter 10. A gain attained by this matched filter 121 is not subjected to the quantitative analysis, but guarantees optimal performance by concurrently reducing noise and interference components.

Another method employed to attain a good gain in the present invention is a method that performs spread spectrum using a random sequence with good characteristics. That is, the transmitter 10 (more correctly, the spreader 105) spreads the band in the frequency domain by multiplying data bit information by an orthogonal code or PN sequence, and the receiver 12 (more correctly, the despreader 122) multiplies the received signal by the same orthogonal code or PN sequence, thereby attaining a gain having the length of the orthogonal code or the PN sequence.

However, since a signal sending band increases in dimensions in proportion to the length of the orthogonal code or the PN sequence being used, the signal being transmitted through a human body may be radiated to the outside of the body, causing interference to users nearby. Therefore, the length of a random code to be used should be selected by taking transmission data rate and limited frequency range into consideration, and it may be difficult to attain a desired performance at a desired high data rate only by using the spread spectrum technology.

Moreover, when an error occurs in one chip within the received spread spectrum symbol due to an error caused by burst noise, processing gain is lost by 2 dB. And, when an error occurs in two chips, processing gain is lost by 4 dB. That is to say, if the number of error chips in the received spread spectrum code is ‘n’, a processing gain that can be attained for a demodulated signal is PG-2n dB. In this case, the spread spectrum system using a band spread code suitable for a limited band range does not guarantee a desired performance.

To resolve this, it is necessary for the interleaver 103 to disperse the burst error in several spread band symbols (that is, to change a burst error to a random error) through block interleaving. In addition, the transmitter 10 requires the channel encoder 102 for using an error correction code, while the receiver 12 requires the channel decoder 125 for determining an error after dispreading the received data. Here, the error correction code is added as redundancy to the original information for correcting an error generated on a channel. By inserting and transmitting the error correction code in this manner, the receiving side is able to correct the error generated on a channel.

From an aspect of encoding scheme, error correction codes can largely be divided into block codes and trellis codes.

Block codes are strong against a burst error, and representative examples thereof include Hamming codes, Golary codes, BCH codes, Reed-Muller codes, Reed-Solomon codes, etc. In general, it is known that (15,11) Hamming codes are subjected to BPSK modulation in AWGN and have an about 1.4 dB gain at 10⁻⁶ BER. Further, it is known that (24,12) Extended Golay codes have 2.4 dB, (127,64) BCH codes have an about 3.3 dB, and RS codes in GF (256) have 3.5 dB coding gain.

Meanwhile, a representative example of trellis code is a convolution code. The convolution code is decoded by Viterbi algorithm, and is strong against a random error. In this case, if soft-decision is applied, approximately 5 dB coding gain can be attained.

Also, there is a concatenation code which combines block codes and trellis codes. The concatenation code is strong against burst errors as well as random errors, thereby maximizing the performance. Codes that combine RS codes and convolution codes or RS codes and turbo codes are often used. It is known that the concatenation code generally attains an about 7.3 dB coding gain.

Further, in terms of decoding scheme, examples of error correction codes include convolutional turbo codes using iterative decoding scheme, block turbo codes, and Low-Density Parity Check Codes (LDPCs), etc. It is known that, at 10⁻⁵ BER, the convolutional turbo code attains about 5 to 8 dB coding gain, while the LDPC code usually attains about 5.8 to 9 dB coding gain.

When redundant information such as an error correction code is added on the transmitting side, bandwidth needed for transmission increases. Therefore, Trellis-Coded Modulation (TCM) was introduced to overcome such a shortcoming. TCM is the combination of coding scheme and modulation scheme, and its merit is that a possible coding gain can be attained without increasing bandwidth. It is known that the TCM scheme can attain about 3.8 dB coding gain when it is used alone, and a maximum of 5.5 dB coding gain when combined with RS codes.

In addition, the intra-body communication system used for services (for example, printing, information exchanging between terminals, credit card settlement, entrance system, bus and subway fare payment, etc.) which do not require real-time process can employ the HARQ technology in order to increase gain. By doing so, the operational SINR (Signal to Interference plus Noise Ratio) of a human body channel may be lowered, thereby attaining an additional gain. Here, the HARQ technique is the combination of an Automatic Repeat request (ARQ) technique (which is a protocol for error control where the receiving side requests the transmitting side to resend damaged data) and channel coding of PHY layer. Further, the HARQ technique does not apply only retransmission as in the ARQ technique, but applies a scheme such as chase combining or Incremental Redundancy (IR) to efficiently combine the already received data and the retransmitted data, thereby enhancing the decoding performance.

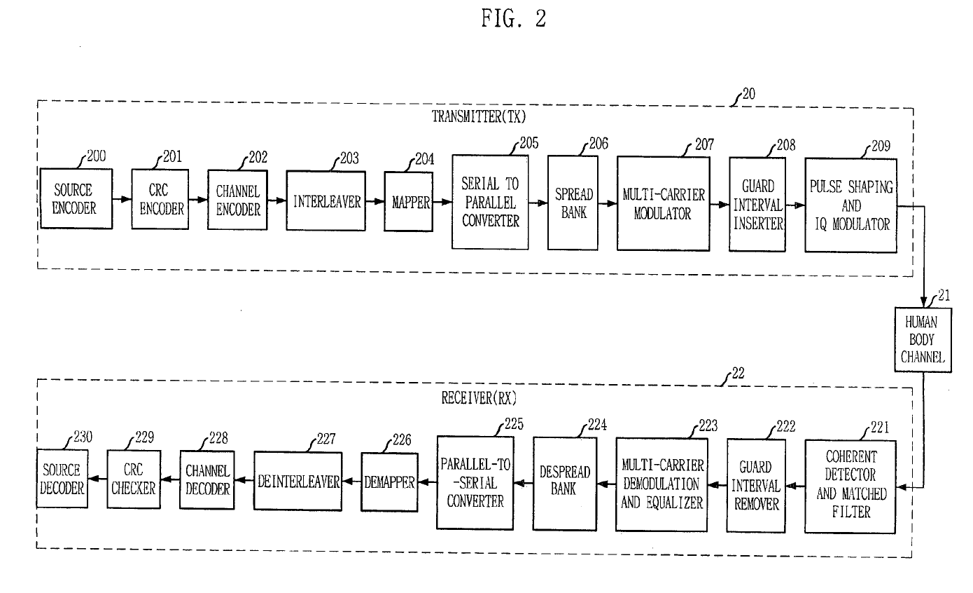

FIG. 2 is a block diagram illustrating an intra-body communication system for high-speed data transmission in accordance with a second embodiment of the present invention, and particularly shows an example of using a multiplexing method for increasing spectrum efficiency in the intra-body communication system as shown in FIG. 1.

A transmitter 20 includes a source encoder 200, a CRC encoder 201, a channel encoder 202 selectively supporting HARQ function, an interleaver 203, a mapper 204, a serial to parallel converter 205, a spread bank 206, a multi-carrier modulator 207, a guard interval inserter 208, and a pulse shaping and IQ modulator 209.

A receiver 22 includes a coherent detector & matched filter 221, a guard interval remover 222, a multi-carrier demodulator and equalizer 223, a despread bank 224, a parallel to serial converter 225, a demapper 226, a deinterleaver 227, a channel decoder 228 selectively supporting HARQ function, a CRC checker 229, and a source decoder 230.

First, a description will be made for the transmitter 20 of the intra-body communication system for high-speed data transmission.

The source encoder 200 encodes source information to digital transmission data, and the CRC encoder 201 inserts a CRC code for error correction on the receiving side. Here, the CRC encoder 201 does not need to be necessarily provided.

The channel encoder 202 performs channel encoding on an output from the CRC encoder 201, and selectively supports the HARQ function. The interleaver 203 performs block interleaving to change a burst error to a random error. Here, the channel encoder 202 together with the interleaver 203 serve as a ‘channel error prevention unit’, which inserts a redundant bit to the transmission data having been encoded by the CRC encoder 201 to correct, on the receive side, an error on a human body channel.

The mapper 204, which is a constellation mapper, symbolizes the transmission data from the channel error prevention unit 202 and 203 by a predetermined modulation method. The serial to parallel converter 205 converts symbols serially outputted from the mapper 204 to parallel arrangement.

Then, the spread bank 206 performs spread spectrum on individual symbols being arranged in parallel by the serial to parallel converter 205, and summates the symbols subjected to the spread spectrum in the unit of chip (refer to FIG. 3). In other words, the spread bank 206 carries out spread spectrum by multiplying each of k symbols having been mapped by the mapper 204 and arranged in parallel by an orthogonal code sequence (e.g., Walsh-Hardamard code), and summates the spread symbols for each chip.

The multi-carrier modulator 207 multiplexes outputs of the spread bank 206 by orthogonal frequencies. That is, it performs multi-carrier modulation on the spread symbols having been added in the unit of chips in the spread bank 206. That is, the multi-carrier modulator 207 causes each lower carrier to have the same bandwidth and sets part of predetermined carriers to a guard band by taking into account of intrinsic characteristics of a human body channel to send a zero carrier, and loads data onto the remaining carriers for transmission. In such a multi-carrier modulation scheme, many lower carriers have orthogonality between themselves and other lower carriers, so they do not influence on each other.

The guard interval inserter 208 inserts a guard interval to the transmission data having been subjected to the multi-carrier modulation in the multi-carrier modulator 207.

Because the intra-body communication is actually a near field communication with a body as a waveguide, it may be assumed that no multipath exists, except for the existence of a very short power diffusion phenomenon. From this perspective, the block 208 inserting the guard interval may be useless or insignificant for the intra-body communication.

However, the power diffusion phenomenon may be prolonged unexpectedly, and in order to deal with the above situation, the guard interval can be efficiently used.

Besides the foregoing, the guard interval inserter 208 may be used in an actual system operation for accurately tracking a coherent location initially in the receiver and then securing processing delay time until the start position of a real data symbol is found, or may be used for performing a tracking function in the middle of data receiving to correct a symbol offset when the receiver has to receive a great number of orthogonal frequency multiplexed data symbols at once. In addition, if an error occurs in the coherent location at the time of establishing an initial coherence and thus an incorrect start position is tracked, the circularity of the intra-body communication channel may break, which leads to deterioration in performance. The guard interval inserter 208 also serves to prevent the performance deterioration in advance.

Meanwhile, the pulse shaping and IQ modulator 209 generates a baseband signal with a band range limited to ‘a frequency range where a human body can retain waveguide properties’ with respect to the transmission data outputted from the guard interval inserter 208, and performs digital quadrature modulation on the baseband signal.

The following is a detailed description for the receiver 22 of the intra-body communication system for high-speed data transmission.

The receiver 22 as depicted in FIG. 2 produces the same gain as the gain produced by each block of the receiver 12 in FIG. 1. The receiver 22 of the present invention performs coherent detection and matched filtering in the coherent detector & matched filter 221, removes a guard interval in the guard interval remover 222, and carries out multi-carrier demodulation and channel equalization in the multi-carrier demodulator and equalizer 223. Then, the despread bank 224 of the receiver 22 concurrently inputs an output signal of the equalizer 223 to ‘k’ despreaders 224, 42, 43, and 44 per sample to obtain a processing gain and recover data. Finally, the receiver 22 recovers original data by way of the parallel to serial converter 225, the demapper 226, the deinterleaver 227, and the channel decoder 228.

A brief explanation on the receiver 22 has been provided. Hereinafter, each of the components included in the receiver will be described in detail.

The coherent detector & matched filter 221 detects, by using a coherent detection method, an original information signal from a signal received through the human body channel 21, and extracts a signal that matches with a pulse shaped transmitted signal from the transmitting side from the detected information signal.

The guard interval remover 222 functions to remove a guard interval from a signal outputted from the coherent detector & matched filter 221. The guard interval remover 222 is needed if the guard interval inserter 208 is provided in the transmitter 20.

The multi-carrier demodulator and equalizer 223 performs multi-carrier de-modulation on plural signals outputted from the guard interval remover 222, and removes, through an equalization process, signal distortion on the human body channel.

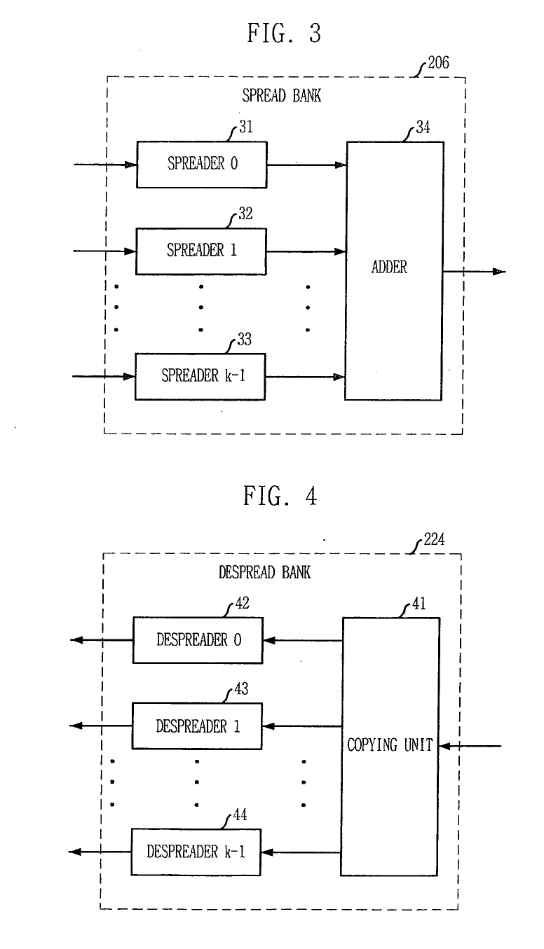

Thereafter, the despread bank 224 copies an input signal from the multi-carrier de-modulator and equalizer 223 per sample generates a plurality of signals, and multiplies each of the generated input signals by an orthogonal code sequence that is different from each other in parallel to recover original data. More details on this will be provided in reference to FIG. 4.

The parallel to serial converter 226 serially arranges the original data outputted in parallel from the despread bank 224, and the demapper 226 demaps this serially arranged original data into data bits.

Next, the deinterleaver 225 deinterleaves the data bits outputted from the demapper 226. The channel decoder 228 serves to perform channel decoding, and selectively support the HARQ function. Here, both the deinterleaver 227 and the channel decoder 228 are for correcting an error on a human body channel with respect to the data bits outputted from the demapper 226, which may be called ‘a channel error correction block’.

In addition, the present invention is provided with the CRC checker 229 to check a frame error. This CRC checker 229 is needed if the CRC encoder 201 is provided the transmitter 20.

Lastly, the source decoder 230 decodes the received data in digital form having the channel error being corrected to corresponding source information.

FIG. 3 is a detailed block diagram of the spread bank shown in FIG. 2 in accordance with the present invention, wherein the despread bank 206 consists of a plurality of spreaders 31 to 33 and an adder 34.

The spreaders 31 to 33 carry out spread spectrum by multiplying each of k symbols being inputted in parallel by an orthogonal code sequences, and the adder 34 summates the spread symbols from each of the spreaders 31 to 33 by chips.

FIG. 4 is a detailed block diagram of the despread bank shown in FIG. 2 in accordance with the present invention, wherein the despread bank 224 consists of a copying unit 41 and a plurality of despreaders 42 to 44.

The copying unit 41 copies an input signal (which has been outputted from the multi-carrier demodulator and equalizer 223) ‘k’ number per sample and concurrently inputs them to the plurality of despreaders 42 to 44, the k number of despreaders 42 to 44 multiply the signals by orthogonal code sequences to recover original data.

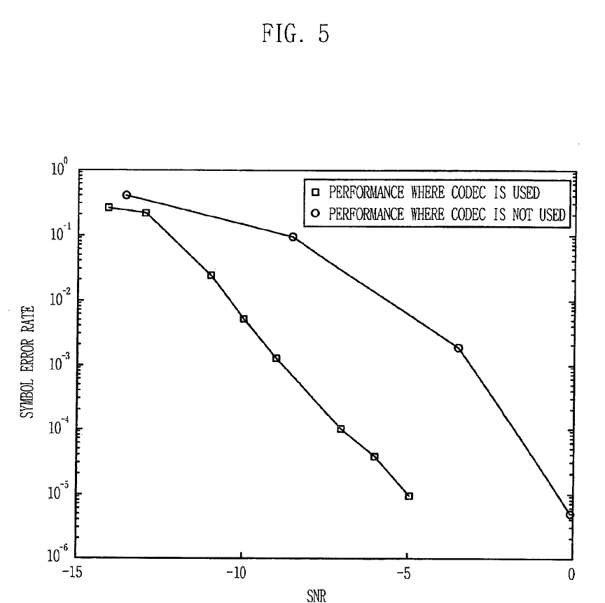

FIG. 5 is a graph comparing performances with or without a convolutional encoder and a Viterbi decoder, wherein performances are compared with respect to SNR axis in case of an intra-body communication channel using a codec and in case of an intra-body communication channel without a codec. For simulation, a convolutional encoder 102 or 202 and a Viterbi decoder 125 or 228 were used for the codec, DSSS scheme was adopted in a modem, and Baker code was utilized as the spread code.

As has been explained so far, the present invention suggested the transmitting/receiving (communication) scheme, in which the frequency range is limited to reduce interference among many users and which enables the receiver to attain a sufficient gain to smoothly recover the originally transmitted signal from interference signals being introduced into the human body from outside. In addition, the multiplexing scheme was described as one way of increasing the frequency usage efficiency while maintaining the gain as it is.

The method of the present invention as mentioned above may be implemented by a software program that is stored in a computer-readable storage medium such as CD-ROM, RAM, ROM, floppy disk, hard disk, optical magnetic disk, or the like. This procedure may be readily carried out by those skilled in the art; and therefore, details of thereof are omitted here.

The present application contains subject matter related to Korean Patent Application No. 2006-0096272, filed in the Korean Intellectual Property Office on Sep. 29, 2006, the entire contents of which is incorporated herein by reference.

While the present invention has been described with respect to the particular embodiments, it will be apparent to those skilled in the art that various changes and modifications may be made without departing from the spirit and scope of the invention as defined in the following claims.

1. A transceiver of intra-body communication system for high-speed data transmission, comprising:
a source encoder for encoding source information to digital transmission data;
a channel error prevention unit for inserting a redundant bit to the encoded transmission data to enable a receiving side to correct an error on a human body channel;
a mapper for symbolizing the transmission data outputted from the channel error prevention unit by a given modulation method;
a spreader for performing spread spectrum on the symbolized transmission data in a frequency domain by using a spread code with a given code length depending on a data transmission rate and limited frequency range; and
a pulse shaping and modulator for generating a baseband signal with a band range limited to a frequency range where the human body retains waveguide properties with respect to the transmission data having been subjected to the spread spectrum in the spreader, and performing digital quadrature modulation on the baseband signal.

2. The transceiver of claim 1, wherein the channel error prevention unit includes:
a channel encoder for performing channel encoding, wherein the channel decoder selectively supports a Hybrid Automatic Repeat request (HARQ) function; and
an interleaver for block-interleaving an output of the channel encoder to change a burst error to a random error.

3. The transceiver of claim 2, further comprising:
a Cyclic Redundancy Check (CRC) encoder, located in front end of the channel error prevention unit, for inserting a CRC code to the transmission data outputted from the source encoder.

4. A transmitter of an intra-body communication system for high-speed data transmission, comprising:
a source encoder for encoding source information to digital transmission data;
a channel error prevention unit for inserting a redundant bit to the encoded transmission data to enable a receiving side to correct an error on a human body channel;
a mapper for symbolizing the transmission data outputted from the channel error prevention unit by a given modulation method;
a serial to parallel converter for converting symbols serially outputted from the mapper to a parallel arrangement;
a spreader for individually diffusing each symbol being arranged in parallel in the serial to parallel converter, and summating the diffused symbols in the unit of chip;
a multi-carrier modulator for performing multi-carrier modulation on the diffused symbols being summated in the unit of chip at the spread means; and
a pulse shaping and modulator for generating a baseband signal with a band range limited to a frequency range where the human body retains waveguide properties with respect to the transmission data having been subjected to the multi-carrier modulation in the multi-carrier modulator, and performing digital quadrature modulating on the baseband signal.

5. The transmitter of claim 4, wherein the multi-carrier modulator causes each lower carrier to have the same bandwidth and sets part of predetermined carriers to a guard band by taking into account of intrinsic characteristics of a human body channel to send the same in a zero carrier form, and loads data onto the remaining carriers for transmission.

6. The transmitter of claim 4, further comprising:
a guard interval inserter for inserting a guard interval to the transmission data having been subjected to the multi-carrier modulation in the multi-carrier modulator.

7. The transmitter of claim 4, wherein the channel error prevention unit includes:
a channel encoder for performing channel encoding, and selectively supporting an HARQ function; and
an interleaver for block-interleaving an output of the channel encoder to change a burst error to a random error.

8. The transmitter of claim 7, further comprising:
a CRC encoder, located in front end of the channel error prevention unit, for inserting a CRC code to the transmission data outputted from the source encoder.

9. A receiver of an intra-body communication system for high-speed data transmission, comprising:
a coherent detector & matched filter for detecting, by using a coherent detection method, an original information signal from a signal received through a human body channel, and for extracting a signal that matches with a pulse shaped transmitted signal on a transmitting side from the detected information signal;
a despreader for despreading data outputted from the coherent detector & matched filterer to recover symbol data;
a demapper for demapping the recovered symbol data from the despreader into data bits;
a channel error corrector for correcting an error on the human channel with respect to the data bits outputted form the demapper; and
a source decoder for decoding the digital received data with the channel error having been corrected in the channel error corrector to source information.

10. The receiver of claim 9, further comprising:
a CRC checker for checking a frame error in the data bits outputted from the channel error corrector, in accordance with a CRC method.

11. The receiver of claim 9, wherein the channel error corrector includes:
a deinterleaver for deinterleaving the data bits outputted from the demapper; and
a channel decoder for performing channel decoding on the data bits outputted from the deinterleavers, wherein the channel decoder selectively supports an HARQ function.

12. A receiver of an intra-body communication system for high-speed data transmission, comprising:
a coherent detector & matched filter for detecting, by using a coherent detection method, an original information signal from a signal received through a human body channel, and extracting a signal that matches with a pulse shaped transmitted signal on a transmitting side from the detected information signal;
a multi-carrier demodulator for performing multi-carrier demodulation on a plurality of signals outputted from the coherent detector & matched filter;
a despreader for copying an input signal from the multi-carrier demodulator per sample to generate a plurality of input signals, and dispreading the plurality of generated input signals in parallel to recover original data;
a parallel to serial converter for serially arranging the original data outputted in parallel from the despreader;
a demapper for demapping the serially arranged data into data bits;
a channel error corrector for correcting an error generated on the human channel with respect to the data bits outputted form the demapper; and
a source decoder for decoding the digital received data with the channel error having been corrected in the channel error corrector to source information.

13. The receiver of claim 12, further comprising:
a guard interval remover for removing a guard interval from a signal outputted from the coherent detector & matched filter.

14. The receiver of claim 12, further comprising:
a copying unit for copying a signal being inputted from the multi-carrier de-modulator per sample to generate a plurality of signals, and outputting the plural signals at the same time; and
a plurality of despreaders for recovering original data by multiplying each of the signals from the copying unit by a orthogonal code sequence.

15. The receiver of claim 12, further comprising:
an equalizer, located in front end of the despreader, for equalizing a multi-carrier demodulated signal outputted from the multi-carrier demodulator.

16. The receiver of claim 12, further comprising:
a CRC checker for checking a frame error in the data bits outputted from the channel error corrector, in accordance with a CRC method.

17. The receiver of claim 12, wherein the channel error corrector includes:
a deinterleaver for deinterleaving the data bits outputted from the demapper; and
a channel decoder for performing channel decoding on the data bits outputted from the deinterleavers, wherein the channel decoder selectively supports an HARQ function.
